(19) United States
(12) Patent Application Publication
(10) Pub. No.: US 2012/0264961 A1
(43) Pub. Date: Oct. 18, 2012

(54) FE3O4-M(AU-LIKE)-NANOPARTICLES FOR ANTIBODY-CONSERVING TARGET-SPECIFIC PLATIN DELIVERY

(75) Inventors: Shouheng Sun, East Greenwich, RI (US); Chenjie Xu, Xiamen (CN)

(73) Assignee: Brown University, Providence, RI (US)

(21) Appl. No.: 13/391,897

(22) PCT Filed: Aug. 25, 2010
(86) PCT No.: PCT/US2010/046625

§ 371 Date: Jun. 28, 2012

Related U.S. Application Data
(60) Provisional application No. 61/237,526, filed on Aug. 27, 2009.

(51) Int. Cl. C07F 15/02

(52) U.S. Cl. 556/31

(57) ABSTRACT

An antibody-conserving method for linking a therapeutic platinum compound to nanoparticles comprising Au Like-Fe₃O₄, which is used for both drug delivery and tumor diagnosis.

The U.S. Government has a paid-up license in this invention and the right in limited circumstances to require the patent owner to license others on reasonable terms as provided for by the terms of the National Institutes of Health/the National Cancer Institute (1R21CA12859).

### FIELD OF THE INVENTION

An antibody-conserving method for linking a therapeutic platinum compound to nanoparticles comprising Fe₃O₄-M(Au-like).

### BACKGROUND

Pt-based platin complexes, such as cisplatin, carboplatin, and oxaliplatin, are well-known generations of anticancer therapeutic agents. One common feature of these square planar Pt complexes is that they contain coordination bonds of Pt—N/Pt—Cl, or Pt—N/Pt—O with two Pt—N bonds in cis-position. Pt—Cl or Pt—O bonds in the complex are chemically much weaker than Pt—N bonds and subject to facile hydrolysis in low Cl⁻ and low pH conditions, giving charged [cis-Pt(NH₃)₂(H₂O)₂]²⁺ that are highly reactive for DNA binding through the N7 atom of either an adenine or guanine base. Without being bound by any particular theory, this binding is believed to de-stack the double helix structure and interrupts a cell's genetics/transcription machinery and repair mechanism, leading to cell death.

Without being bound by any particular theory it is believed that cisplatin exhibits sub-optimal therapeutic efficacy because of (i) poor solubility and limited cellular accumulation; (ii) binding by plasma proteins leading to excretion from the body unchanged; (iii) the active Pt—Cl bond being subject to facile substitution by other biomolecules; and (iv) lack of specificity for tumor cells. Therapeutic regimens, as a result, require larger doses and, consequently, lead to greater or more severe side effects.

Various particle carriers, especially magnetic iron oxide nanoparticle carriers, have been proposed and studied. To date, reported drug delivery properties of iron oxide nanoparticles are of limited therapeutic promise due to the limitations in linking both targeting agent (antibody) and therapeutic drug (e.g, a platin) on the same particle surface while preventing or reducing inactivation of the constituent parts. Some inactivation is attributable to drugs antibody interactions. The uncontrolled distribution of the targeting agent and drug on the same particle surface adversely affects therapeutic results.

Particular reference is made to Xu, C. J. et al., “Au—Fe₃O₄ Dumbbell Nanoparticles as Dual-Functional Probes” Angew. Chem. Int. Ed., 2008, 47, 173-176 and Xu, C. J. et al., “Dumbbell-like Au—Fe₃3O₄ Nanoparticles for Target—Specific Platin Delivery” J. Am. Chem. Soc., 2009, 131 (12), 4216-4217 the teachings of which are incorporated herein by reference.

A significant concern in preparing nanoparticles with both antibody and therapeutic platin is to achieve attachment of the platin while conserving antibody activity. In some instances, attachment of the platin to the Au-like end will be accompanied by either blocking of the antibody's exposed surface or degradation of the antibody's surface structure such as to reduce activity.

Without limitation, particular attention is drawn to currently approved antibodies such as cetuximab (Erbitux® ImClone Systems Merck KGaA), panitumumab, (Vectibix®, Amgen), rituximab, (Rituxan® and MabThera®), bevacizumab (Avastin®, Genentech/Roche), alemtuzumab (Campath®, MabCampath® or Campath-1H®), infliximab (Remicade®), adalimumab (Humira®) and abciximab (ReoPro®, Centocor). Trastuzumab (Herceptin®) is a monoclonal antibody that is believed to interfere with the HER2/neu receptor. Further contemplated are peptides/proteins such as RGD, P-selectin, E-selectin, tumstatin, endostatin, and canstatin and other targeting biomolecules with a propensity for tumor attachment (e.g. folic acid).

Any of the foregoing are useful as an L2 antibody.

Callibrating therapeutic regimens employing both small molecule drugs and antibodies has proved to be a hurdle. Seitz, K. & Zhou, H. Pharmacokinetic Drug-Drug Interaction Potentials for Therapeutic Monoclonal Antibodies: Reality Check. J Clin Pharmacol 47, 1104-1118 (2007); Panayotatos, N. Drug-binding Cavities in Long-Lived Biologics: Cause for Concern but Also Potential Benefit. J Clin Pharmacol 48, 1208-1211 (2008). In addition, preparatory protocols for nanoparticles which (i) maintain antibody activity, (ii) platin activity, and pharmaceutically acceptable suspensions of nanoparticles bearing both presents additional technological problems. The inventors have spent two years in determining proper conditions and the suitable characterics for linkage of platin drugs to nanoparticles while maintaining therapeutic levels of antibody activity. As used herein, “unsuitable” reaction conditions are those which either decrease the antibody activity by about 40% or more or breakdown the nanoparticles structure (or both). In addition, process steps which lead to the aggregation of nanoparticles are also understood to be unsuitable conditions. A protocol substantially which avoids of these pitfalls is termed a bio-acceptable protocol.

### BRIEF DESCRIPTION OF THE DRAWINGS

FIG. 1 is a schematic illustration of a dumbbell-like Au—Fe₃O₄ nanoparticle coupled with an antibody and platin complex for target-specific platin delivery.

FIG. 2 is a scheme for antibody-conserving modification of Au surface of Au—Fe₃O₄ nanoparticles.

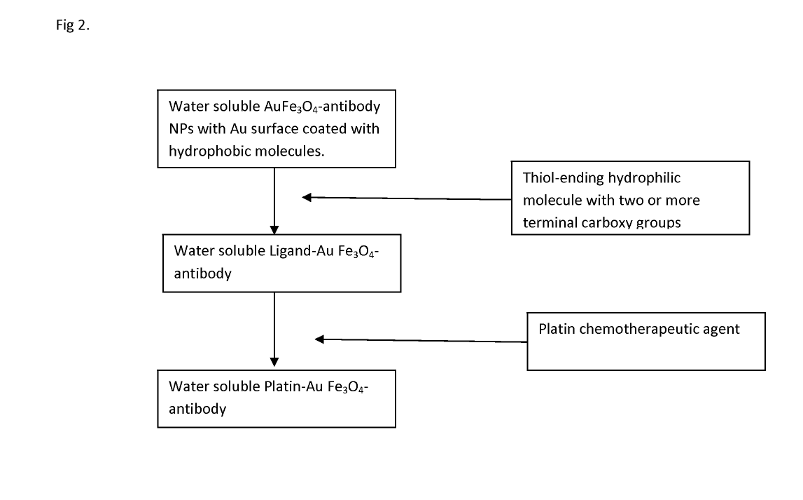

FIG. 3 is a scheme illustration of a branch structure L1. (waveline represents linkage).

### SUMMARY OF THE INVENTION

This invention presents an antibody-conserving method for linking a therapeutic platinum compound to nanoparticles comprising Au-like-Fe₃O₄ comprising the steps of

(a) dissolving an L1 molecule in solvent;

(b) mixing the resulting liquid with said Au—Fe₃O₄ nanoparticles at a ratio from about 1000:1 to about 10,000:1 for not more than about 6 hours at a temperature of about 4° C. under light protection;

(c) removing substantially all free L1 from nanoparticles system. In some instances the Au-like component comprises gold, silver, platinum or a gold-silver mixture. The method also includes the solvent in step comprising water, PEG, and dimethylformamide.

In some embodiments method using Fe₃O₄ is replaced by a pharmaceutically acceptable metal oxide other than Fe₃O₄ such as Mn₂O₃, Fe₂O₃ Co₂O₃, Ni₂O₃, CuO, or ZnO.

In particular embodiments the invention includes a method of preparing a platin drug coupled to a targeting agent-Au—Fe3O4 conjugate including the following steps of:

(a) dissolving an L1 or L3 molecule in solvent;

(b) mixing the resulting liquid with said Au—Fe₃O₄ nanoparticles at a ratio from about 1000:1 to about 10,000:1 for not more than about 6 hours at a temperature of about 4° C. under light protection; and,

(c) removing substantially all free L1 from said platin drug coupled to a targeting agent-Au—Fe3O4 conjugate.

### DETAILED DESCRIPTION OF THE INVENTION

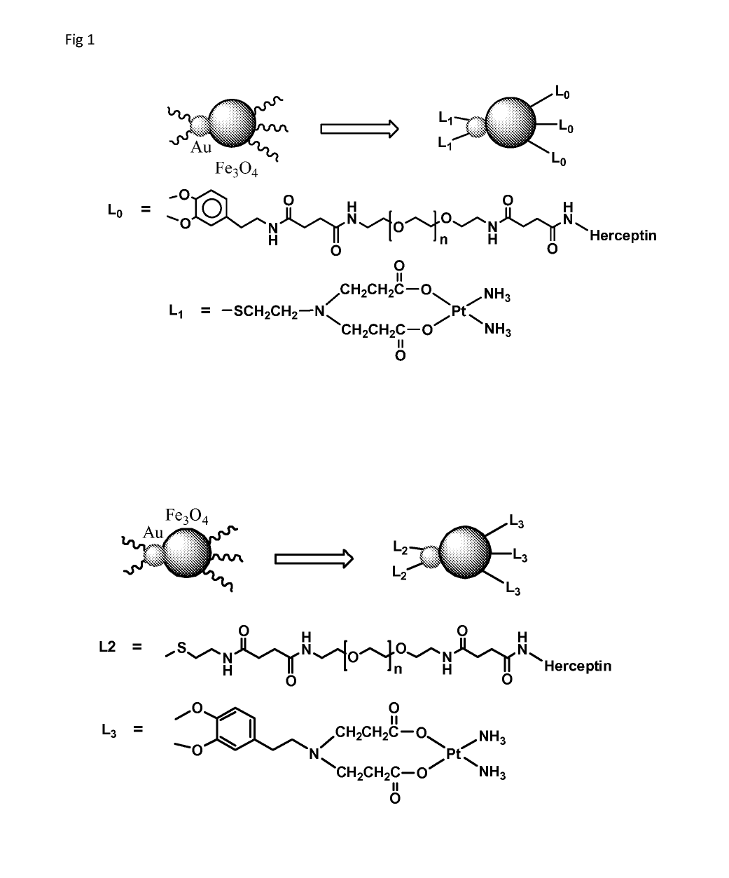

Without being bound by any particular theory, several factors are noted relative to the hydrophobic molecular replacement on Au surface of Au—Fe₃O₄-Antibody. This is depicted in FIG. 1 as a schematic illustration of a dumbbell-like Au—Fe₃O₄ nanoparticle coupled with a platin complex, L1, for target-specific platin delivery and an antibody, L2 (e.g., Herceptin). The iron component is represented as the larger sphere and the gold component is represented as the smaller sphere. For the component depicted as smaller, it is contemplated to substantially comprise any Periodic Table Group 11 element including copper, gold, and silver and mixtures thereof whether as composites, true alloys or compressed powders (collectively “Au-like”).

Looking at FIG. 1, L0 and L3 shall mean ligands on the iron side of the nanoparticle. L1 and L2 shall mean the ligands on the gold side of the particle.

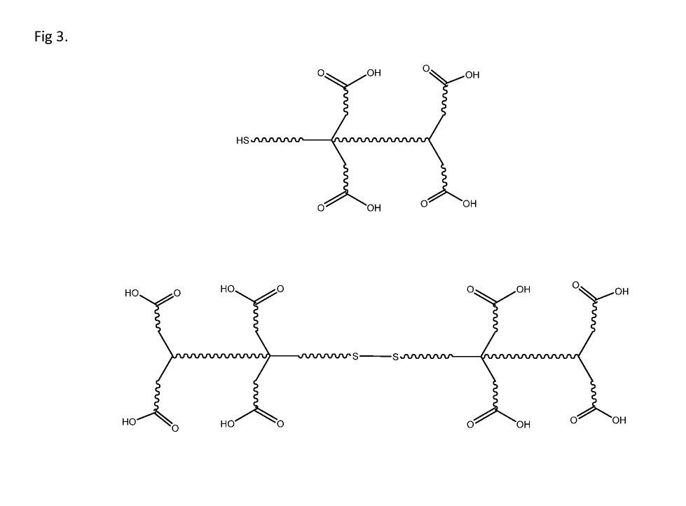

In one embodiment, the antibody is linked to Au—Fe₃O₄ surface through amide bond, the Au—Fe₃O₄-Antibody system is purified through gel filtration chromatography. This process is comprehensive for Au, Ag, Pt, and mixtures thereof. Next, a molecule with a thiol (the instant process includes both thiol group (HS—) and disulfides (—S—S—)) at one end and two or more carboxy groups at the other end (L1). In some embodiments this includes a branch structure (FIG. 3) was dissolved in pure deionized water. L1 shall mean a molecule wherein a sulfur bonds with Au-like surface while using carboxylic groups to link platin. It is understood that L1 includes molecules with thiol at one end and multiple carboxy groups at another end. L1 also includes the molecules with a disulfide bond in a central position with carboxy groups at the ends.

The solution was then mixed with Au—Fe₃O₄ nanoparticles in solution for 6 hours while stirring at 1000 rpm in an ice bath or ice water bath. The molar ratio between nanoparticles and L1 ranged from 1000:1 to 10000:1. Free ligands were then removed by gel filtration chromatography.

In addition to water, suitable solvents include poly(ethylene glycol) (“PEG”), chloroform, dichloromethylene, hexane, dioxane, DMF, and DMSO.

Particular note is made of PEG from about 600 to about 20,000 Dalton. In the present invention PEG is used to link the thiol group with carboxylic groups.

This method is robust and not specific as to a particular antibody. Antibody is typically linked to Fe₃O₄ surface, but linkage to non-metal/oxide particle surfaces in multiple core nanoparticles system are contemplated, e.g. Ag—Fe2O3, Au—Fe₃O₄—Ag. Alternative nanoparticle systems are further described in Arumugam et al. “Self-assembly and cross-linking of FePt nanoparticles at planar and colloidal liquid-liquid interfaces.,” J Am Chem Soc. 2008 Aug. 6; 130(31):10046-7; McDaniel et al., “Size and growth rate dependent structural diversification of Fe₃O₄/CdS anisotropic nanocrystal heterostructures,” ACS Nano. 2009 Feb. 24; 3(2):434-40, the teachings of which are incorporated herein by reference in their entirety.

Reaction time depends on the L1 ligands. If L1 is thiol-ending, a reaction time of about 3 hours is suitable. If the reaction extends past about 6 hours, the antibody specificity will be compromised. But if the L1 comprises a disulfide bond to link with Au-like surface, a reaction time of about 6 hours or more is appropriate. Note that —S—S-bonds, —SH bond and amino groups are important groups to maintain the activity of antibody. An —SH will generally react with —SH and —S—S— in antibody to form —S—S— bonds and thus de-activate the antibody. An —S—S— bond will generally maintain the original —SH bonds in antibody. An —SH bond is often easier to react with Au as compared with —S—S—.

The reaction temperature should be kept around 4° C. This maintains antibody specificity and reduces cross-reaction between antibody and free ligand.

Substantially complete removal of free ligand after Au surface modification improves the successful linkage of platin. Free ligand in the solution is usefully monitored (such as by with HPLC) to confirm substantially complete removal. Residual free ligand will react with platin precursor later to deactivate the platinum. In some embodiments the reaction is through the thiol-platinum bond.

Ratios between L1 and nanoparticles of between about 1,000:1 and 10,000:1 are noted. Selection of a specific ratio is dependent, in part, on the structure of L1. When employing thiol-ending L1, ratios of about 1000:1 are useful. With disulfide containing L1, higher ratios in the 10,000:1 range are useful. Broadly, a ratio between thiol-ending L1 and nanoparticles was determined based on an estimate of the number of exposed/surface atoms, here Au, in a nanoparticle. For a 3 nm gold nanoparticle, about 400 atoms are exposed or on the surface. About 1600 atoms are estimated as exposed or on the surface of a 6 nm gold particle and about 2800-3000 atoms on an 8 nm particle. A useful starting condition is to have L1 as a 2× excess compared with the estimated number surface gold (or Group 11) atoms. For disulfide based ligands, the reactivity with Au atoms is lower. In such instances about a 10× excess is useful.

Platin attachment conditions can be broadly adapted for therapeutic platin pharmaceuticals including cisplatin, carboplatin, oxyliplatin, satraplatin, picoplatin and aroplatin. There particular linking strategies are noted for the L1-Au—Fe₃O₄-Antibody system.

In one embodiment, the platinum drug is suspended in aqueous solution and later mixed with the nanoparticles solution under light protection. Exposure to light will cause decomposition of most platinum drugs and should be controlled. Dimethylformamide (DMF) is an example of a solvent useful to enhance solubility which is also sparing of antibody activity.

The reaction time is adjusted based on the platinum precursor chosen. For cisplatin, attention is drawn to a reaction time of about 6 hours or less. Longer reaction times, particularly beyond 12 hours, reduce the activity of the nanoparticles. Without being bound by any particular theory, it is believed that free cisplatin decomposes in aqueous solution and, over 6 to 12 hours, forms multinuclear Pt complexes. In addition, antibody reactivity may be adversely impacted by free cisplatin. It is believed that cisplatin dissolved in aqueous solution will react with amino groups or —S—S groups in antibody or bind into the cavity of antibody. Prophylactic steps include removing unreacted or excess cisplatin (collectively “free” cisplatin) such as by centrifugation. In one embodiment, low speed centrifugation removed cisplatin precipitate, and following high speed centrifugation separated nanoparticles from free cisplatin.

For platins other than cisplatin, if the drugs have a better water solubility than cisplatin a decrease in the reaction time is useful. As an example, carboplatin has a solubility 22 mg/ml compared with cisplatin's 2 mg/ml. For carboplatin the reaction time is reduced from 6 hours to 1 hour. For optimization of ratio control adjustment is useful also to take nanoparticle composition into consideration. Reaction temperature is usefully maintained at about 4° C.

Besides directly reacting platin precursors with nanoparticles, the platin can also be premade from those precursors before conjugating with nanoparticles. E.g. cisplatin is then reacted with AgNO₃ (molar ratio 1:2) in deionized water under light protection to remove chloride ion. It is believed that chloride occupied sites will be re-occupied with water molecules which react with carboxylic groups. The modified platinum drug is next mixed with nanoparticle at 4° C. under light protection for about 3 to about 6 hours. The molar ratio between platinum and nanoparticles should around 500:1 to 5000:1. An optimal ratio is related, in part, to the actual size of Au particles and L1. For example, 3 nmAu-18 nmFe₃O₄NPs with L1 as in FIG. 1 suggests a ratio 500:1 since the surface Au number is around 400.

In the practice of the instant method it will be understood that a targeting agent such as an antibody is usefully coupled to Au—Fe3O4 like nanoparticles by a variety of methods. Attention is particularly drawn to the method of dissolving an L0 (where L0 is not antibody) molecule in solvent (chloroform); mixing the resulting liquid with Au—Fe₃O₄ nanoparticles (same solvent or 10% or less Hexane solvent) at a ratio from about 1000:1 to about 10,000:1 for not more than about 6 hours at room temperature under inert gas protection. Then centrifuge the solution at high speed (>5000 rpm) to precipitate the NPs. The NPs are washed with the mixture of Hexane/chloroform to remove substantially all free L0 from nanoparticles system. Subsequently, the conjugates are dispersed in water or PBS buffers. After filtration through 200 nm filter, the conjugates are coupled with antibody through EDC/NHS chemistry. In the foregoing method, antibody is linked to Fe3O4 surface. In embodiments of this method L0 comprises a dopamine derivative including [dopamine, 3,4-Dihydroxy-L-phenylalanine, 2,4,5-Trihydroxy-DL-phenylalanine, 6-Hydroxydopamine hydrobromide and Benserazide hydrochloride] different molecular weight polyethylene glycol (PEG), and PEG with different ending functional groups (e.g., NH2-PEG-NH2, HOOC-PEG-COOH, NH2-PEG-COOH).

Another useful method is dissolving an L2 (where L2 is not platin) molecule in solvent (chloroform); mixing the resulting liquid with said Au—Fe₃O₄ nanoparticles (same solvent or 10% or less Hexane solvent) at a ratio from about 1000:1 to about 10,000:1 for not more than about 6 hours at room temperature under inert gas protection. Then centrifuge the solution at high speed (>5000 rpm) to precipitate the NPs. The NPs are be washed with the mixture of Hexane/chloroform to remove substantially all free L0 from nanoparticles system. Subsequently, the conjugates are dispersed in water or PBS buffers. After filtration through 200 nm filter, the conjugates are coupled with antibody through EDC/NHS chemistry. In this method, antibody is linked to Au surface. In embodiments of this method L2 comprises a thiol group and an amine group, which includes Cysteamine, 4-Aminothiophenol, 3-Mercaptopropylamine.

Surface Au number per Au NPs (3 nm) are conveniently calculated to sufficient accuracy with reference to the following parameters: (i) the atomic radius of Au atom is 0.1442 nm, (ii) in the present examples each Au NP is assumed to be a sphere with diameter 3 nm, and (iii) the Au atoms are assumed to be close-packed on the surface. Thus, for the present calculation, the surface area of Au NPs comprises the sum of all Au atom's cross-section area.
Surface area of 3 nm Au NPs: A=4πR²=4*3.14*(1.5*10⁻⁹)²=28.26*10⁻¹⁸ m³
Cross-section area of one Au atom is α=πr²=3.14*(0.1442*10⁻⁹)²=0.0653*1⁻¹⁸ m³.

Thus, a calculated number of surface Au atoms per ideal NP is

$$n = \frac{A}{a} = 432$$

is generally useful for Li to gold-like particle calculations. It is to be understood that the attachment of the gold nanoparticle to an associated nanoparticle such as Fe₃O₄, and flaws or imperfections in the nanoparticle surface will such calculated numbers.

This procedure is useful to modify the Group 11 metal surface in the multiple-core nanoparticle systems, including the following examples: Au—Fe₃O₄, Ag—Fe₃O₄, AuAg—Fe₃O₄, Pt—Fe₃O₄. AuAg means Au and Ag alloy or mixture. Au:Ag ratios from about 1:9 to about 9:1 are noted. Nanoparticles of about 2 nm to 20 nm are also noted. Similar ratios are noted for Cu.

For attaching the platin, in one embodiment 2 mg (6.7×10⁻⁶ mol) cisplatin suspension (deionized water, 20 mg/ml) was added to the nanoparticles solution (L1-Au—Fe₃O₄-Antibody, 8 nm Au-18 nm Fe₃O₄, 3.5×10⁻⁹ mol). After stirring for 6 hrs under light protection in ice-water bath, the solution was subjected to centrifugation at 400 rpm for 5 min. Then the supernatant was subject to high speed centrifugation (8000 rpm) for 30 min to precipitate out the nanoparticles. Then the precipitated nanoparticles were re-dispersed in deionized water and centrifuge again (8000 rpm) to ensure removal of free cisplatin. The final product is re-dispersed in deionized water and preserved at 4° C.

We claim:

1. An antibody-conserving method for linking a therapeutic platinum compound to nanoparticles comprising Au-like-Fe₃O₄ comprising the steps of
(a) dissolving an L1 molecule in solvent;
(b) mixing the resulting liquid with said Au—Fe₃O₄ nanoparticles at a ratio from about 1000:1 to about 10,000:1 for not more than about 6 hours at a temperature of about 4° C. under light protection;
(c) removing substantially all free L1 from nanoparticles system.

2. The method of claim 1 wherein said Au-like component comprises gold, silver, platinum or a gold-silver mixture.

3. The method of claim 2 wherein said Au-like component comprises gold.

4. The method of claim 2 wherein said Au-like component comprises silver.

5. The method of claim 2 wherein said Au-like component comprises platinum.

6. The method of claim 2 wherein said Au-like component comprises a gold-silver mixture.

7. The method of claim 1 wherein the solvent in step (a) comprises water.

8. The method of claim 1 wherein the solvent in step (a) comprises PEG.

9. The method of claim 1 wherein the solvent in step (a) comprises dimethylformamide.

10. The method of claim 1 wherein Fe₃O₄ is replaced by a pharmaceutically acceptable metal oxide other than Fe₃O₄.

11. The method of claim 11 wherein said metal oxide is Mn₂O₃ or Fe₂O₃.

12. A method of preparing a platin drug coupled to a targeting agent-Au—Fe3O4 conjugate including the following steps of:
(a) dissolving an L1 or L3 molecule in solvent;
(b) mixing the resulting liquid with said Au—Fe₃O₄ nanoparticles at a ratio from about 1000:1 to about 10,000:1 for not more than about 6 hours at a temperature of about 4° C. under light protection; and,
(c) removing substantially all free L1 from said platin drug coupled to a targeting agent-Au—Fe3O4 conjugate.
